(19) United States
(12) Patent Application Publication
(10) Pub. No.: US 2013/0097046 A1
(43) Pub. Date: Apr. 18, 2013

(54) System and Method of Providing Transactional Privacy

(71) Applicants: Balachander Krishnamurthy, New York, NY (US); Vijay Erramilli, Barcelona (ES); Pablo Rodriguez, Barcelona (ES); Josep Maria Pujol, Barcelona (ES)

(72) Inventors: Balachander Krishnamurthy, New York, NY (US); Vijay Erramilli, Barcelona (ES); Pablo Rodriguez, Barcelona (ES); Josep Maria Pujol, Barcelona (ES)

(21) Appl. No.: 13/648,560

(22) Filed: Oct. 10, 2012

Related U.S. Application Data
(60) Provisional application No. 61/547,326, filed on Oct. 14, 2011.

(51) Int. Cl. G06Q 30/08

(52) U.S. Cl. 705/26.3

(57) ABSTRACT

A user is prevented from being identified at each of a plurality of sites. An indication to sell access to the user at one of the plurality of sites is received. A personal information marketplace is provided to run an auction to sell the access to the user at the one of the plurality of sites. In response to a sale of the access to the user at the one of the plurality of sites to an aggregator, access to track the user at the one of the plurality of sites while maintaining anonymity of the user is provided to the aggregator.

This application claims the benefit of U.S. Provisional Patent Application No. 61/547,326, filed Oct. 14, 2011, the entire disclosure of which is incorporated by reference herein.

### TECHNICAL FIELD

This specification relates generally to systems, methods and apparatus of providing transactional privacy and more particularly to systems, methods and apparatus of providing transactional privacy to users while also providing a personal information marketplace to sell access to users.

### BACKGROUND

Online users may visit websites and perform various tasks while visiting the websites. For example, users may visit websites to access information about a product, read the news, read an editorial or a blog, write a review, post media, engage in online conversations (e.g. emails or chat), purchase items, or browse.

Users having privacy concerns may be apprehensive with respect to sharing information related to their online activities collected by various advertisers, websites, agencies, etc. Specifically, users may be concerned with tracking of their habits by various advertisers, etc. and may be concerned with how the information related to their activities is tracked, used and/or sold.

### SUMMARY

In accordance with an embodiment, a user is prevented from being identified at each of a plurality of sites. An indication is received from the user to sell access to the user at one of the plurality of sites. A personal information marketplace is provided to run an auction to sell the access to the user at the one of the plurality of sites. In response to a sale of the access to the user at the one of the plurality of sites to an aggregator, access to track the user at the one of the plurality of sites is provided to the aggregator while maintaining anonymity of the user.

In an embodiment, the preventing the user from being identified further includes substituting a real internet protocol address of the user with a random proxy internet protocol address. The random proxy internet protocol address dynamically changes when the user visits a site.

In an embodiment, in response to the sale of the access to the user at the one of the plurality of sites to an aggregator, a fixed proxy internet protocol address is assigned to the user for the plurality of sites and the fixed proxy internet protocol address is provided to the aggregator.

In an embodiment, the fixed proxy internet protocol address is assigned for a predetermined period of time.

In an embodiment, the fixed proxy internet protocol address changes to a new fixed proxy internet protocol address after the predetermined period of time.

In an embodiment, the user is rewarded in response to the sale of the access to the user at the one of the plurality of sites to an aggregator.

In an embodiment, the plurality of sites include a plurality of websites and the access to track the user allows the aggregator to track the user when the user visits one of the plurality of websites.

In an embodiment, the access to track the user is location based and allows the aggregator to track the user when the user visits any location.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to provide services in accordance with an embodiment;

FIG. 2 shows functional components of an exemplary user device in accordance with an embodiment;

FIG. 3 shows functional components of an exemplary entity in accordance with an embodiment;

FIG. 4 shows a functional components of an exemplary aggregator in accordance with an embodiment;

FIG. 5 is a flowchart depicting a method of providing services to an aggregator in accordance with an embodiment;

FIG. 6 shows communication between a proxy and various components in accordance with an embodiment;

FIG. 7 is a flowchart depicting a method of a user opting-in to a service accordance with an embodiment; and

FIG. 8 shows components of a computer that may be used to implement the invention.

### DETAILED DESCRIPTION

Monetizing personal information is a key economic driver of the online industry. Users may be more concerned about their privacy, as evidenced by increased media attention. A mechanism referred to as “transactional” privacy may be applied to personal information of users. Users concerned about privacy may choose to share all, some or none of the information associated with their online habits. Therefore, users may decide what personal information is released and put on sale in exchange for receiving compensation. Online habits include user click-throughs, website visits, frequency of website visits, amount of time spent on websites, keyword searches, or any other patterns associated with websites visited, etc. For example, users may decide to share some information related to their click-throughs on popular websites while not sharing information related to click-throughs on other niche websites. Users may be encouraged to share their information when aggregators properly compensate the users and the users are provided with certain assurances relating to maintaining their anonymity when sharing their information. Therefore, aggregators may offer compensation to users in exchange for obtaining access to all or some of the users' information.

An aggregator may be defined as a corporation, a website, etc., that collects a specific type of information from a source (such as an entity that provides a marketplace for such a source). The aggregator may acquire and/or collect the information to be used for many purposes. The aggregator may further store and organize the information for use at any time.

In an embodiment of the present disclosure, aggregators purchase access to users' information. Aggregators may purchase access for a multitude of uses. For example, aggregators may purchase access in order to serve ads to users. Truthfulness and efficiency, attained through an unlimited supply auction, ensure that the interests of all parties in this transaction are aligned. In an unlimited supply auction, the goods being auctioned off may be duplicated or reproduced with ease. Hence, the aggregators may access the goods (e.g. the goods being information pertaining to users) which may be supplied to one or more aggregators without limits on the supply of the goods in an unlimited supply auction.

Transactional privacy is integrated in a privacy preserving system that curbs leakage of information. These mechanisms combine to form a market of personal information that can be managed by one or more trusted entities that can implement the transactional privacy.

Online services may be largely fueled by the collection and use of personal information (PI). Online entities collect PI of users in exchange for services and these entities monetize this data primarily via advertisements. Information aggregators have found new ways to collect and use this data and are increasingly collecting information. Various leakages of PI have been identified in websites including traditional online social networks and their mobile counterparts. As aggregators move into monetizing more of PI, users may be concerned about protecting their privacy. Users may also be concerned with organizations that collect and/or trade the users' personal information without consent of users or compensating them. The term privacy is defined as a user's ability to seclude information about him/her. The user may wish to selectively reveal some information, while concealing some other information which the user deems private. The user may decide what and how much information to reveal to aggregators, while concealing some private information by a using a mechanism called transactional privacy (TP). TP is designed to be general enough to handle different types of PI, such as demographic information, web browsing data and location information. To sell PI, auctions may be used, where users put up PI and aggregators place bids to gain access to the corresponding user's information. Aggregators can valuate users' PI and decide on the amount to bid, and if they win, gain access to the user with this information for a limited time. Aggregators may not strategically manipulate the market and users may be compensated in proportion to aggregators' valuation. Unlimited supply auctions may be used, and in particular the exponential mechanism that is simple to implement and provides good guarantees on truthfulness and market efficiency.

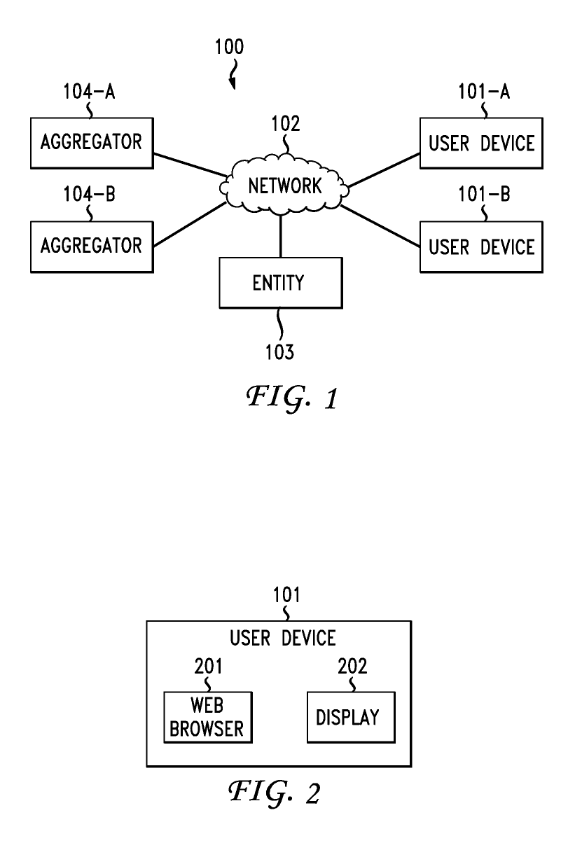

FIG. 1 shows a communication system 100 that may be used to provide transactional privacy services, in accordance with an embodiment. Communication system 100 includes a network 102, an entity 103, an aggregator 104-A, an aggregator 104-B, a user device 101-A, and a user device 101-B. Communication system 100 may include one, two, or more than two aggregators and user devices. Each of user device 101-A and user device 101-B may be accessible by one or more users.

In the exemplary embodiment of FIG. 1, network 102 is the Internet. The Internet can be accessed either through wired devices or wireless devices.

The term user device 101 is used herein to refer to one or more user devices, including user device 101-A and user device 101-B. User device 101 may be any device that enables a user to access various sites including online sites on the World Wide Web via the Internet. User device 101 may be connected to network 102 through a direct (wired) link, or wirelessly. User device 101 may have a display screen (not shown) for displaying information. For example, user device 101 may be a personal computer, a laptop computer, a workstation, a mainframe computer, a mobile communication device such as a wireless phone, a personal digital assistant, cellular device, a laptop computer, a netbook, a tablet device, etc. Other devices may be used.

The term aggregator 104 is used herein to refer to one or more aggregators, including aggregator 104-A and aggregator 104-B. An aggregator may be defined as an entity that collects information. The aggregator may gather information from various sources.

FIG. 2 shows functional components of user device 101 in accordance with an embodiment. User device 101 includes a web browser 201 and a display 202. Web browser 201 may be a conventional web browser used to access World Wide Web sites via the Internet, for example. Display 202 provides display of webpages, documents, text, images, software applications, and other information.

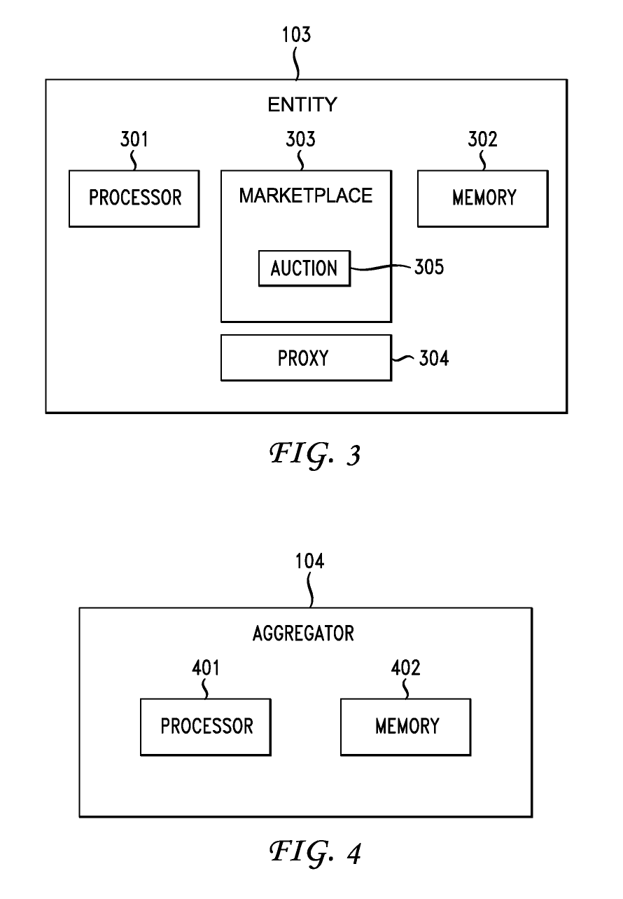

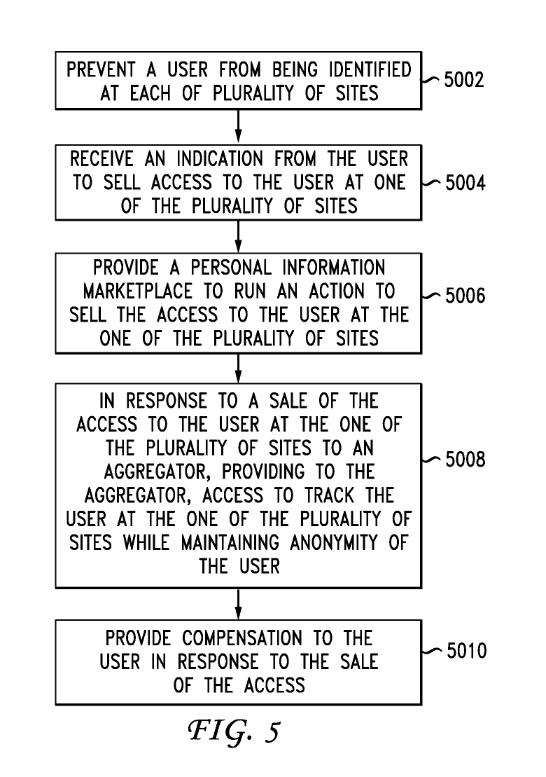

FIG. 3 shows functional components of entity 103 in accordance with an embodiment. Entity 103 includes a processor 301, a memory 302, a proxy 304 and a marketplace 303. Marketplace 303 is used to host an auction 305. In another embodiment, proxy 304 and marketplace 303 may be external to entity 103 or may be managed by another entity other than entity 103. Details regarding auction 305 and marketplace 303 are discussed herein with respect to FIG. 5.

An identity preservation mechanism based on a hybrid browser/proxy architecture that enables such transactions may be provided. This mechanism curtails the flow of information to aggregators, protecting against well-known forms of privacy leakages, handing back control of PI to the respective user. By implementing an economic transaction, for fair valuation of the information the leakage has to be curbed, forcing aggregators to come to entity 103.

Transactional privacy may be guided by three principles:

(i) users should have control of their PI and decide what gets released,

(ii) aggregators should be able to derive maximum utility of the data they obtain, and

(iii) aggregators may be best positioned to price the value of users' PI.

Users may be paid to compensate for their loss of utility via information release. The task of calculating the loss of utility may be left to the user. However, an easier and more intuitive task may be to allow the user to decide what information he/she would like released, instead of the utility of that information, while providing relevant information as a guideline to aid the user in their decision-making. Detailed information about each visit (time spent on a site, etc.) may be easily incorporated. The user may be provided with (via a simple browser plug-in) the set of sites he/she has visited in a sorted order (e.g. descending) according to their global popularity (e.g. based on the number of other users who have visited that site). In this embodiment, the first listed site will be the most visited site by all users, etc.

FIG. 5 is a flowchart depicting a method of providing services to an aggregator in accordance with an embodiment. At step 5002, a user is prevented from being identified at each of a plurality of sites. A user employing user device 101 is prevented from being identified at each of a plurality of sites, by entity 103. The user may opt-in to a service provided by entity 103 to mask the user and/or user device 101's identity, habits, website click-through's, etc. Entity 103 uses proxy 304 to replace, mask or substitute user device 101's real internet protocol address with a random proxy internet protocol address, where the random proxy internet protocol address dynamically changes every time the user visits a site. Details regarding the proxy will be described herein below. In other embodiments, other methods of preventing the user from being identified may be used. Other methods are described in Measuring Privacy Loss and the Impact of Privacy Protection in Web Browsing, Symposium On Usable Privacy and Security (SOUPS) 2007, Jul. 18-20, 2007, Pittsburgh, Pa., USA, authored by Krishnamurthy et al.

At step 5004, an indication from the user to sell access to the user at one of the plurality of sites is received. Entity 103 receives, via network 102, an indication from user device 101 to sell access to the user at one or more sites.

At step 5006, a personal information marketplace is provided to run an auction to sell the access to the user at the one of the plurality of sites. Entity 103 provides marketplace 303 to run auction 305 to sell the access to the user at the one or more of the plurality of sites. Marketplace 303 may facilitate auction 305 in one of many ways. For example, marketplace 303 may facilitate auction 305 to be provided to one or a plurality of aggregators. The aggregators may place bids, via auction 305, to access the user. Auction 305 may be a timed auction, an auction that ends when a particular monetary amount for a bid is reached, or may be any other type of auction.

Entity 103 provides aggregators with some information relating to the access prior to the aggregators bidding on the auction. For example, entity 103 may provide some information about the types of available access. Types of available access may include details about what the aggregators are placing bids on (e.g. access to users that frequently visit sports entertainment websites, access to users that are expecting parents, etc.). Types of available access may also include a threshold of privacy purchasing the access would provide. For example, users that are more concerned with their privacy may offer a minimal level of information to the winning aggregator while less concerned users may offer to release a more detailed level of information to the winning aggregator. The minimal level of information may include a list of hobbies, favorite books or television shows. In an embodiment, the minimal level of information may include providing no personal information about the user to the winning aggregator.

Users disclose to entity 103 a count of their activity on different sites (e.g. how many visits the users have made to a website's URL). Aggregators may get a count of the users' activities on various websites and/or information about the website visits including the time of the visits, the duration of the visits, the URL's of the websites, etc.

Suppose now that the aggregator wishing to place a bid in an auction is an infomercial telemarketer. The aggregator may wish to purchase access to users in a particular age group who visit a particular website every week, having a particular education level, and having a particular household income. Entity 103 may allow the aggregator to input such requests to bid on access to users that meet certain qualifications set by the aggregator.

Prior to the auction, when the user opts-in to the marketplace and agrees to offer for sale a part of all of the information associated with the user, the user may agree to offer some personal information (e.g. information related to the user's activities on various websites, his/her education level, favorite book, etc.). Any personal information that the user agrees to release is provided as raw information to the aggregator(s). The aggregator(s) may then use the raw information of a user to decide if the aggregator(s) is/are interested in accessing the user. Suppose now that the user's habits and/or qualifications fit the infomercial telemarketer's needs. Prior to bidding on the auction, the telemarketer may be informed that there is a user the telemarketer may be interested in based on the user's personal information. The interested aggregator may be provided with the raw information of the user and can then place a bid on the user by engaging in auction 305, which is a part of marketplace 303. Additional details about the auction are described below.

Prior to placing a bid in an auction, aggregators may valuate the information to determine how much the information is worth. In an embodiment, the valuation is based on the user's personal information (e.g. information related to the user's activities on various websites, his/her education level, favorite book, etc.) which is provided to aggregators prior to bidding in the auction. The valuation may be performed by using various algorithms and formulas. Aggregators have experience extracting value from PI and are able to assess revenues on a short-term basis through the sale of goods or ad-space, compared to the long-term risk a user must calculate in dealing with privacy. Finally, aggregators may typically deal with many customers, and may take a little more risk in overestimating or underestimating the value of access, as opposed to users who are more risk averse. The calculated valuation is then used to bid on the auction to access the user. Details regarding the valuation are described below.

Referring now to step 5008, in response to a sale of the access to the user at the one or more of the plurality of sites to an aggregator, access to track the user at the one of the plurality of sites is provided to the aggregator while maintaining anonymity of the user. When auction 305 ends, the sale of the access to the user at one or more of the plurality of sites chosen by the user is provided to aggregator 104 by entity 103, via network 102. Aggregator 104 is provided with access to track the user at the one or more of the plurality of sites while entity 103 (and proxy 304) maintains the anonymity of the user.

In an embodiment, aggregator 104 may be provided with access for a limited amount of time. Aggregator 104 may need to repurchase access after the limited amount of time expires. The repurchasing steps may be the same as steps 5002, 5004, 5006 and 5008.

Referring again to step 5004, the user may choose to grant a winning aggregator with access to his/her information whenever the user visits a website (e.g. APopularNewsWebsite[dot]com). The user may choose to grant the winning aggregator with access to one or more websites and the aggregator is only granted access to the user's visits to that particular website(s). Therefore, when the user visits other websites (e.g. ANotSoPopularNicheWebsite[dot]com), the user's information is kept anonymous. In an embodiment, multiple aggregators may win an auction and the multiple aggregators may then be supplied with access to the user. Therefore, multiple winning aggregators may each be supplied with access to the user.

In an embodiment, suppose that a first user who offers for sale his/her access to a site with high global popularity (e.g. APopularNewsWebsite[dot]com) may have a lower risk of being identified as compared to a second user who chooses to offer for sale his/her access to a niche site (e.g. ANotSoPopularNicheWebsite[dot]com).

In an embodiment, the step of preventing the user from being identified further comprises substituting a real internet protocol address of the user with a random proxy internet protocol address. The random proxy internet protocol address dynamically changes when the user visits a site.

Referring now to step 5010, compensation is provided to the user in response to the sale of the access. The user employing user device 101 is rewarded and/or compensated in response to the sale of the access to the user at the one or more of the plurality of sites to aggregator 104. The user is compensated by entity 103. For example, the compensation may in a form of a gift card, a money transfer code, a coupon, a voucher, a discount, access to exclusive content on a website, etc.

The plurality of sites may comprise a plurality of websites and the access to track the user allows aggregator 104 to track the user when the user visits the plurality of websites.

When the user opts-in to the marketplace and agrees to offer for sale a part of all of the information associated with the user, in an embodiment, the user may agree to offer for sale at least a portion of his/her information at a minimum price. Any compensation received by the user is sent by entity 103, and not by the aggregator. In an embodiment, the aggregator may never directly contact the user, in order to ensure that user's privacy is protected. In another embodiment, the user may not set a minimum price. In an embodiment, a timed auction or any other type of auction may be used. One or more aggregators may then place bids on the user's information by engaging in auction 305, which is a part of marketplace 303. When aggregator 104 wins the auction and purchases the user's and/or user device 101's information, aggregator 104 may use the information and the user habits for various purposes. The user may be compensated (e.g. by being offered monetary compensation, coupons, rebates, etc.) for his/her information.

In an embodiment, the user may create a “blacklist” that lists any aggregators the user does not wish to sell his/her information to under any circumstance. If a particular aggregator is placed on the user's blacklist, the aggregator will not be given any personal information (or any information) about the user and would be unable to bid on accessing the user.

Suppose now that the user employing user device 101 visits APopularNewsWebsite[dot]com, which is one of the plurality of websites that the user agreed to offer for sale during auction 305. Aggregator 104 (i.e. the aggregator that won the auction) is then provided with a utility to track the user when the user visits APopularNewsWebsite[dot]com. In an embodiment, this utility may be implementing using a fixed proxy internet protocol (IP) address. The user device associated with the user is assigned a fixed proxy IP address for the selected website(s) and this fixed proxy IP address associated with the user is provided to aggregator 104 that won the auction. Therefore, when aggregator 104 is provided with the proxy generated IP address associated with the user, aggregator 104 may track or otherwise view the habits associated with the user when visiting APopularNewsWebsite[dot]com.

In an embodiment, the user's information is offered to aggregator 104 in such a way that the user's anonymity is maintained. Details regarding how the anonymity of the user's identity is maintained are described herein. There are other ways of anonymizing a user's identity. Other methods are described in Measuring Privacy Loss and the Impact of Privacy Protection in Web Browsing, Symposium On Usable Privacy and Security (SOUPS) 2007, Jul. 18-20, 2007, Pittsburgh, Pa., USA, authored by Krishnamurthy et al.

Proxy

In response to the sale of the access to the user employing user device 101 at the one or more of the plurality of sites to aggregator 104, a fixed proxy internet protocol (IP) address is assigned to the user (i.e. user device 101) for the one or more of the plurality of sites. The fixed proxy IP address is provided to aggregator 104 when purchasing access to the user for these sites. In this case, the fixed proxy IP address may be assigned for a predetermined period of time. The fixed proxy IP address changes to a new fixed proxy IP address after the predetermined period of time ends. The fixed IP address may change to preserve the user's information and to ensure that the user is properly and fairly compensated for providing his/her information. Proxy 304 may assign and/or handle all IP addresses.

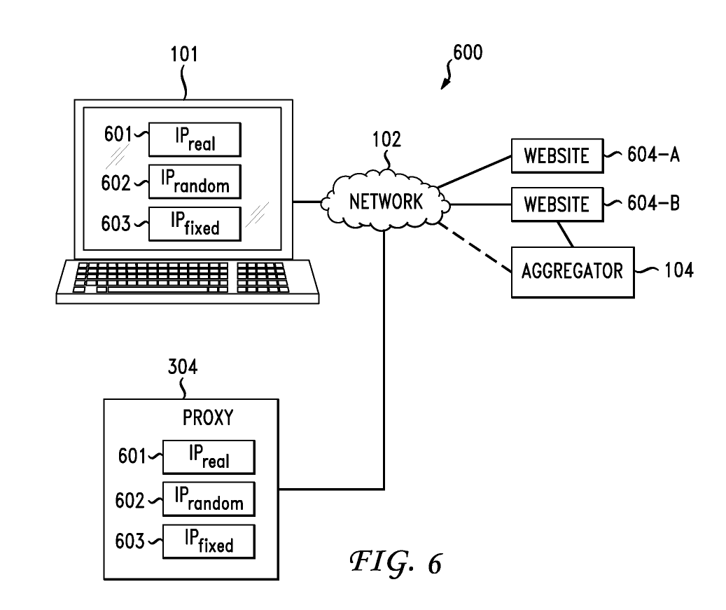

Referring now to FIG. 6 which shows communication between a proxy and various components, suppose now that the user employing user device 101 browses multiple sites: website 604-A and website 604-B. Aggregator 104 may track the user when the user visits one or both of websites 604-A and 604-B. Aggregator 104, upon aggregating information about the user (or multiple users) may then sell the aggregated information to one or more websites. One or both of websites 604-A and 604-B may be hosted by a different server or the same server or owned by a different entity or the same entity. User device 101 may access a World Wide Web page on website 604-B that may be viewed using a conventional Web browser, for example. In an embodiment, website 604-B is typically able to access the IP address of any device visiting website 604-B.

Suppose now that the user employing user device 101 accesses network 102. User device 101 has an associated Internet Protocol (IP) address, IPᵣₑₐₗ 601. When the user browses webpages on website 604-A using user device 101, all requests for accessing website 604-A go through proxy 304. When user device 101 requests a webpage, it sends a Hypertext Transfer Protocol (HTTP) request to website 604-A. The request is sent through the user device's browser to the server that hosts the webpage. This may be done using GET. The server replies by including the contents of the page with a response header in its response. The packet may contain lines that could request the browser to store cookies. “Set-Cookie” may be included in the packet. Set-Cookie is a directive for the browser to store a Cookie and send it back in future requests to that server. Set-Cookie is a header and defines the operating parameters of a HTTP transaction. Other header fields may be included in the packet. As the Set-Cookie directive is sent by the server to the browser, this can be intercepted by a proxy in the middle and the proxy can masquerade as a legitimate user. The response is sent from the server to the browser and the response is trapped by the proxy. Set-Cookie, if present, is always sent from the server to the browser. Details regarding proxy 304 are described below. Proxy 304 traps all Set-Cookie HTTP response headers and masquerades as a legitimate user. Because proxy 304 masquerades the user, website 604-A is unable to access IPᵣₑₐₗ 601. Proxy 304 masks IPᵣₑₐₗ 601 by replacing it with a proxy IP address, IP_{random} 602. IP_{random} 602 may be a proxy IP address that is not associated with IPᵣₑₐₗ 601. Rather, IP_{random} 602 is a randomly generated IP address. Proxy 304 may provide a new IP_{random} 602 periodically or IP_{random} 602 may change each time the user using user device 101 visits a new website or webpage.

When aggregator 104 is provided with access to the user's and/or user device 101's information (e.g. as a result of winning the auction or by other means), proxy 304 fixes a proxy IP address, IP_{fixed} 603, to user device 101. Aggregator 104 is provided with IP_{fixed} 603 which is used as the proxy IP address for the user only for websites that were agreed upon as a result of the auction. For example, if the user employing user device 101 only agreed upon providing an aggregator with access to the user for websites X, Y, and Z, then IP_{fixed} 603 is used as the IP address of user device 101 only for websites X, Y, and Z. For other websites, IP_{random} 602 may be used as the IP address of user device 101. In an embodiment, IPᵣₑₐₗ 601 may never be released. By using IP_{fixed} 603, the user's anonymity is maintained even when an aggregator is provided access to the user. That is, the user's real IP address is never exposed.

The aggregator that won the auction to gain access to the user may use IP_{fixed} 603 to deliver a service to the user. For example, the aggregator may provide coupons, targeted ads, content, or other information to the user using IP_{fixed} 603. The aggregator may target the user by using IP_{fixed} 603 and sending the service to the user via proxy 304. Again, the user's anonymity is maintained.

In accordance with an embodiment, every time the user accesses a website, proxy 304 may mask IPᵣₑₐₗ 601 by replacing it with IP_{random} 602 and IP_{random} 602 may be regenerated providing a new IP address every time the user visits a website.

Providing the aggregator access to raw information (as a result of the aggregator winning the auction) may constrain the aggregators to access data through limited variables that are deemed safe to release. Many aggregators may run specialized algorithms on the data sets. Aggregators may not agree to be forced to disclose the algorithms or to constrain the data.

Auction

As described above, prior to placing a bid, aggregators may valuate the information to determine how much the information is worth. The valuation may be performed by using various algorithms and formulas. Aggregators have experience extracting value from PI and are able to assess revenues on a short-term basis through the sale of goods or ad-space, compared to the long-term risk a user must calculate in dealing with privacy. Finally, aggregators may typically deal with many customers, and may take a little more risk in overestimating or underestimating the value of access, as opposed to users who are more risk averse.

In an embodiment, aggregator 104 may store various formulas, algorithms and instructions in memory 402. Memory 402 may also include databases storing user habit data related to data acquired as a result of winning auctions offered by the marketplace.

Suppose that the set of users are represented by I, and each user is represented by index i. J represents the set of sites and the elements of the sites are represented by index j. Index j may be a uniform resource locator (URL) (e.g. for web browsing) or may be a geographical location (e.g. represented by longitude and latitude). The geographical location may be used by global positioning system (GPS) or in a cellular and/or mobile network environment. Suppose that users disclose a simple count of their activity on different sites, denoted by μᵢ(j). μᵢ(j) may be vector that indicates how many visits a user has made to either a URL or a location. In an embodiment, a similar model may be applied to a vector indicating time, duration, order of visits, etc. When a user opts-in to the marketplace, the user indicates a subset Si⊂J that contains all the sites the user has agreed to be tracked on and share with an aggregator that wins auction of the user's information. The aggregator, upon winning the auction and being provided access to the user's information and IP_{fixed} 603, would be able to uniquely identify the user whenever he/she visits the agreed upon sites. The winning aggregator is provided with μᵢ(j) for jεSi.

A set of aggregators are represented by K, where each aggregator is indexed by k. Intuitively, aggregator k may be willing to pay to access the user's habits and/or information as long as the price to acquire the habits and/or information is smaller than the additional revenue rₖ the aggregator can profit. In an embodiment, the good being sold on the market is access to user' habits and/or information. This good may be sold to multiple aggregators with no marginal cost of reproduction; hence, in an embodiment, the market may be thought of as having an unlimited supply. In an embodiment, extensions for an aggregator to buy exclusive access can be included.

In the auction, we assume that each aggregator, k in K, bids a maximum price p_{i,k} and that each aggregator, k, is ready to pay to access user i. Assuming that the fixed price set is p and all willing bidders pay p, the total revenue is given by:

$$R ( ( pi , k ) k ∈ K , p ) = {\sum }_{k ∈ K} p \times II \{ p \leq pi , k \}$$

When p>max_{kεK} p_{i,k}, the revenue will be zero, as no aggregators bid on the information because it is priced too high. In an embodiment, p may be chosen to maximize the above sum. In order to do so, first, an initial value is assigned to p according to a measure v on [symbol] and then this measure is re-weighed to chose the actual price used. To re-weigh, an exponential function that puts more weight on high value of R is used, according to a parameter ε>0. Hence the probability density function (PDF) of the chosen price is given by:

$$\frac{exp ( ɛ R ( {( {p}_{i , k} )}_{k ∈ K ,} p ) ) v ( p )}{{\int }_{0}^{∞} exp ( ( ɛ R ( {( {p}_{i , k} )}_{k ∈ K ,} s ) ) v ( s ) d s}$$

Note that this density may always be defined as long as the integral is finite, and note that the function R is zero for p sufficiently large. The initial distribution of p may be chosen according to the Lebesgue measure on [symbol] , such that v(p)=1. By using ε, noise is added around the value maximizing the revenue, given the set of bids. In an embodiment, a bidder may be prevented from winning more than a factor exp(ε) when a cheating attempt is made while still reaching a revenue that is within a good bound of the optimal value, denoted “OPT,” if the number of aggregators are large.

The expected revenue is

$$OPT - 3 \frac{ ln ( e + OPT {e}^{2} m )}{e}$$

where m is the number of buyers in the optimal case. Thus, although the randomization causes revenue from a given set of bids to be lower, truthful bidding means the set of bids will be higher, ending up with better revenue than if we allowed bidders to cheat.

By using this information provided to the aggregator, the aggregators may build behavioral profiles over time for users to entice advertisers. For example, the aggregator may buildup a profile over time, to further help with targeting advertisement. The aggregator may collect data based on the information acquired from users to better serve the users. In an embodiment, home improvement websites may utilize aggregators to gather information in order to offer coupons and/or discounts to users that frequently visit the home improvement websites. The coupons and/or discounts may be offered by way of online advertisement. In an embodiment, the user may be provided with an option to opt-in or opt-out of receiving these targeted ads.

In an embodiment, upon winning the auction for user 101's information, aggregator 104 is provided with IP_{fixed} 603 by entity 103, via network 102. Aggregator 104 may chain multiple purchases together. However, in order to prevent the aggregator from uniquely identifying or singling out user 101, IP_{fixed} 603 may be reassigned after a predetermined period of time (e.g. after 1 week, after 6 months, etc.).

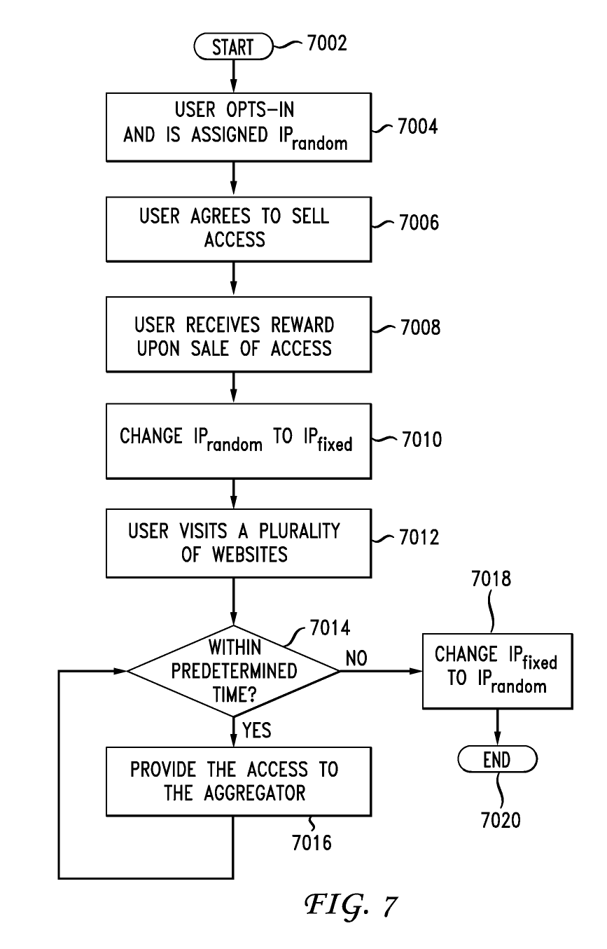

FIG. 7 is a flowchart depicting a method of a user opting-in to a service accordance with an embodiment. At step 7002, the method starts. At step 7004, the user opts-in and is assigned an IP address, IP_{random}. The user employing user device 101 opts-in to the service offered by entity 103, via network 102. When the user opts-in to the service, the user is issued IP_{random} 602 by proxy 304.

At step 7006, the user agrees to sell access to his/her information. The user employing user device 101 agrees to sell access to part or all of his/her information to aggregator 104, via network 102, through entity 103. The access may be provided through auction 305, offered by marketplace 303.

In an embodiment, the browser of user device 101, is a lightweight plug-in that provides the following functionality:

(i) opts-out users of ad-networks and activates Do-not-track, showing intent,

(ii) provides the user with a mechanism to help him/her decide which URLs he/she is willing to put on the market,

(iii) prevents leakage (e.g. cookies, super cookies, 1-pixel bugs, etc.), and

(iv) helps manage multiple users accessing the same device—provides profiles with personalized settings for each user.

Referring again now to FIG. 7, at step 7008, the user receives a reward upon sale of access. After an auction for the user's habit/information ends and aggregator 104 is provided with the user's information, the user employing user device 101 is rewarded by entity 103, via network 102. The reward may be in a form of a gift card, a money transfer code, a coupon, a voucher, a discount, access to exclusive content on a website, etc.

At step 7010, the user's IP address is changed from IP_{random} 602 to IP_{fixed} 603. Entity 103 and proxy 304 changes IP_{random} 602 to IP_{fixed} 603 and when the user visits a plurality of websites, as depicted by step 7012, proxy 304 provides IP_{fixed} 603 to the websites.

At step 7014, it is determined whether the user visits the plurality of websites within a predetermined time. Entity 103 (and/or proxy 304) determines whether or not the user visits the websites within the predetermined time. The predetermined time may be 48 hours, for example. The predetermined time may be an agreed upon time between aggregator 104 and entity 103 (in agreement with user device 101) at the time of the auction. In response to determining that the user visits the plurality of websites within the predetermined time, (e.g. a “yes” decision is made to decision box 7014) at step 7016, access is provided to the aggregator. Entity 103 provides access to user device 101's habits to aggregator 104. The process then loops back to step 7014.

In response to determining that the user visits the plurality of sites after expiration of the predetermined time, (e.g. a “no” decision is made to decision box 7014) at step 7018, IP_{fixed} 603 is changed to IP_{random} 602. When entity 103 determines that the time period agreed upon by the user and the aggregator has expired, entity 103 sends instructions to proxy 304 to change IP_{fixed} 603 to IP_{random} 602. The process then ends at step 7020.

In an embodiment, suppose that a user employing user device 101 is named Alice. Alice's device has an IP address IPᵣₑₐₗ 601 which is used when Alice browses the web, if Alice has not opted-in to the service provided by entity 103. If Alice has opted-in to the service, all her requests go through proxy 304. Furthermore, proxy 304 traps all Set-Cookie HTTP response headers by other parties and masquerades as a legitimate user. No party is privy to IPᵣₑₐₗ 601, which is kept a secret, but rather sees IP_{random} 602 that changes each time the user visits a new page. In an embodiment, this may be similar to using a mix-network.

Next, suppose Alice decides to put her information up for sale in the auction which may run regularly (e.g., daily, to near real-time for a particular location). If the auction is successful, the proxy 304 fixes an IP_{fixed} 603 for the user until the next auction is run. IP_{fixed} 603 is passed to the winning bidders (e.g. aggregator 104), only for the sites that Alice agreed upon. Otherwise, if the auction is unsuccessful or ends without a winner, IP_{random} 602 is used, as described above. In either case, the real IP address, IPᵣₑₐₗ 601, is never released.

Suppose now that Alice browses to multiple sites belonging to the same aggregator. If the aggregator has purchased Alice's information and is able to track Alice's habits, the aggregator can use this information in any way. For example, the aggregator may build a behavioral profile for Alice to entice advertisers. After every auction of Alice's information, a new IP_{fixed} 603 is provided to the aggregator. The aggregator may chain multiple purchases.

Note that Alice's future browsing remain monetizable as IP_{fixed} 603 may be reassigned. In particular, even if the aggregator accumulates information to profile a user whose information has been purchased in an auction, the aggregator may need to pay again to recognize this user later after completion of the original auction.

In an embodiment, for TP to be effective, the present system curtails the leakage of information and prevents identification while browsing. The present system may allow users access to all content without being tracked by aggregators while imposing a minimum overhead.

Online Advertising

Considering online advertising, companies may select targeted ads they want displayed and send them to the aggregator. Aggregator 104 may push ads to the user, via proxy 304 that forwards the ads to the user on the sites he/she put for sale. If the user clicks on an ad, the anonymizing proxy handles the click, removing the real IP of the user. The proxy establishes a connection to the server hosting the advertisement (e.g. may be a content delivery network (CDN) or a cloud provider) using the fixed IP address for the user so that the advertiser/aggregator can perform accounting. The response may be handled by proxy 304. In accordance with an embodiment, even if the advertisers/CDN/cloud provider are in collusion with the aggregator, no personal information is leaked (i.e. the real IP address is obfuscated).

As described above, users choose what to share. The user decides what information is too private and what he/she is comfortable releasing to aggregators. TP may allow application developers to obtain PI for personalized services by directly linking them to the owners of the PI (e.g. the users). In an embodiment, developers may be able to decrease capital costs they would incur in building mechanisms to learn more about their respective users.

By implementing transactional privacy, economic incentives for the user may increase the adoption and the engagement of TP. The sale of raw information, albeit with the user's choice and consent is provided to the aggregators. Services provided by entity 103 are a concrete architecture with transactional privacy at the core to realize such an information market.

Entity 103 may have the following roles: act as the legal go-between for the users and the aggregators, implement TP by preventing leakage of users' information, allow users to put information for sale in a transparent manner, run auction mechanisms, enforce payments, and handle any issues arising from users and aggregators. In an embodiment, these services may be offered for a small percentage of the users' revenues. A trusted hardware and/or operating system may provide these services. The trusted system may also control which information is accessed on the device or goes through the network. In an embodiment, it may be important to vet both bidders and users to make sure that all provided information is legitimate. In another embodiment, users may be aggregated into groups of users, prior to auctioning, thereby increasing the value of the sale of access to the users. For example, entity 103 may group a large number of users (e.g. 100,000 users) prior to running the auction. Purchasing access to a group of users may be more valuable to aggregators as opposed to purchasing access to individual users.

In an embodiment, entity 103 may provide additional services to aggregators 104. For example, suppose aggregator 104 wishes to purchase access to a large number of users. As an added value, entity 103 may provide additional services regarding one of the users who is considered a “heavy user” (an individual who spends a lot of time on the Internet or more time on the Internet than an average user) for free or for an additional cost. This information is provided only if the heavy user has granted permission to sell access to his/her information after opting in to the service.

In an embodiment, location-based services could also be used when providing access to aggregators. For example, aggregators may wish to purchase access to users within a certain geographical vicinity. When the users are located within the geographical vicinity, the aggregator is then granted access to the user. In an embodiment, the users may inform entity 103 which areas and/or locations they wish to grant access to the aggregators, and which areas and/or locations they may not wish to grant access to the aggregators. Therefore, access to the user is only provided for the locations the user agrees to release. For example, suppose that when a user visits a city on vacation, the user is interested in receiving offers and/or coupons in that city. The user may alert entity 103 that he/she is interested in selling access and in exchange, the user is provided with offers and/or coupons. The user may also sell access to his/her current physical location, when the user is employing a mobile device. Based on the user's current location, aggregators may then aggregate information based on the access to the user and in turn, offer coupons to the user. In an embodiment, the access to track the user is location based and allows the aggregator to track the user when the user visits any location. Suppose now that the user returns to the city where the user resides. The user may not wish to release access to his/her residential city. Therefore, access will not be provided when the user's location changes to his/her residential city.

Additionally, the user may be interested in receiving ads when in a certain location. The aggregators may then provide ads to the user who has opted in and agreed to be provided with the ads based on the user's location. The location of users may be determined in a number of ways. In an embodiment, the users themselves may input their location upon opting in. In another embodiment, the users' location may be determined based on a global positioning system in communication with the user's device or if the user is operating a mobile device, the location may be received from the mobile device.

The method steps described in FIGS. 5 and 7 may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 5 and 7. Certain steps of the methods described herein, including one or more of the steps of FIGS. 5 and 7, may be performed by a server or by another processor in a network-based cloud-computing system. Certain steps of the methods described herein, including one or more of the steps of FIGS. 5 and 7, may be performed by a client computer in a network-based cloud computing system. The steps of the methods described herein, including one or more of the steps of FIGS. 5 and 7, may be performed by a server and/or by a client computer in a network-based cloud computing system, in any combination.

Systems, apparatus, and methods described herein may be implemented using a computer program product tangibly embodied in an information carrier, e.g., in a tangible non-transitory machine-readable storage device, for execution by a programmable processor; and the method steps described herein, including one or more of the steps of FIGS. 5 and 7, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

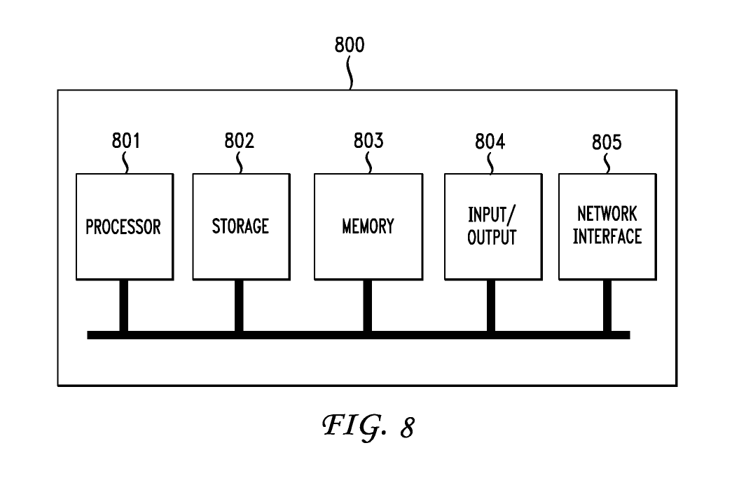

A high-level block diagram of an exemplary computer that may be used to implement systems, apparatus and methods described herein is illustrated in FIG. 8. Computer 800 includes a processor 801 operatively coupled to a data storage device 802 and a memory 803. Processor 801 controls the overall operation of computer 800 by executing computer program instructions that define such operations. The computer program instructions may be stored in data storage device 802, or other computer readable medium, and loaded into memory 803 when execution of the computer program instructions is desired. Thus, the method steps of FIGS. 5 and 7can be defined by the computer program instructions stored in memory 803 and/or data storage device 802 and controlled by the processor 801 executing the computer program instructions. For example, the computer program instructions can be implemented as computer executable code programmed by one skilled in the art to perform an algorithm defined by the method steps of FIGS. 5 and 7. Accordingly, by executing the computer program instructions, the processor 801 executes an algorithm defined by the method steps of FIGS. 5 and 7. Computer 800 also includes one or more network interfaces 805 for communicating with other devices via a network. Computer 800 also includes one or more input/output devices 804 that enable user interaction with computer 800 (e.g., display, keyboard, mouse, speakers, buttons, etc.).

Processor 801 may include both general and special purpose microprocessors, and may be the sole processor or one of multiple processors of computer 800. Processor 801 may include one or more central processing units (CPUs), for example. Processor 801, data storage device 802, and/or memory 803 may include, be supplemented by, or incorporated in, one or more application-specific integrated circuits (ASICs) and/or one or more field programmable gate lists (FPGAs).

Data storage device 802 and memory 803 each include a tangible non-transitory computer readable storage medium. Data storage device 802, and memory 803, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 804 may include peripherals, such as a printer, scanner, display screen, etc. For example, input/output devices 804 may include a display device such as a cathode ray tube (CRT) or liquid crystal display (LCD) monitor for displaying information to the user, a keyboard, and a pointing device such as a mouse or a trackball by which the user can provide input to computer 800.

Any or all of the systems and apparatus discussed herein, including aggregator 104, user device 101, entity 103, browser 201, display 202, processor 301, marketplace 303, auction 305, proxy 304, memory 302, processor 401, and memory 402, may be implemented using a computer such as computer 800.

One skilled in the art will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
preventing a user from being identified at each of a plurality of sites;
receiving an indication from the user to sell access to the user at one of the plurality of sites;
providing a personal information marketplace to run an auction to sell the access to the user at the one of the plurality of sites; and
in response to a sale of the access to the user at the one of the plurality of sites to an aggregator, providing to the aggregator, access to track the user at the one of the plurality of sites while maintaining anonymity of the user.

2. The method of claim 1, wherein the preventing the user from being identified further comprises substituting a real internet protocol address of the user with a random proxy internet protocol address, and wherein the random proxy internet protocol address dynamically changes when the user visits a site.

3. The method of claim 1, further comprising:
in response to the sale of the access to the user at the one of the plurality of sites to an aggregator:
assigning a fixed proxy internet protocol address to the user for the plurality of sites; and
providing the fixed proxy internet protocol address to the aggregator.

4. The method of claim 3, wherein the fixed proxy internet protocol address is assigned for a predetermined period of time.

5. The method of claim 4, wherein the fixed proxy internet protocol address changes to a new fixed proxy internet protocol address after the predetermined period of time.

6. The method of claim 1, further comprising:
rewarding the user in response to the sale of the access to the user at the one of the plurality of sites to an aggregator.

7. The method of claim 1, wherein the plurality of sites comprise a plurality of websites and wherein the access to track the user allows the aggregator to track the user when the user visits one of the plurality of websites.

8. The method of claim 1, wherein the access to track the user is location based and allows the aggregator to track the user when the user visits any location.

9. A tangible computer readable medium storing computer program instructions, which, when executed on a processor, cause the processor to perform operations comprising:
preventing a user from being identified at each of a plurality of sites;
receiving an indication from the user to sell access to the user at one of the plurality of sites;
providing a personal information marketplace to run an auction to sell the access to the user at the one of the plurality of sites; and
in response to a sale of the access to the user at the one of the plurality of sites to an aggregator, providing to the aggregator, access to track the user at the one of the plurality of sites while maintaining anonymity of the user.

10. The tangible computer readable medium of claim 9, wherein the preventing the user from being identified further comprises substituting a real internet protocol address of the user with a random proxy internet protocol address, and wherein the random proxy internet protocol address dynamically changes when the user visits a site.

11. The tangible computer readable medium of claim 9, wherein the first frame comprises a third party application.

12. The tangible computer readable medium of claim 9, wherein the processor is configured to perform further operations comprising:
in response to the sale of the access to the user at the one of the plurality of sites to an aggregator:
assigning a fixed proxy internet protocol address to the user for the plurality of sites; and
providing the fixed proxy internet protocol address to the aggregator.

13. The tangible computer readable medium of claim 12, wherein the fixed proxy internet protocol address is assigned for a predetermined period of time.

14. The tangible computer readable medium of claim 13, wherein the fixed proxy internet protocol address changes to a new fixed proxy internet protocol address after the predetermined period of time.

15. The tangible computer readable medium of claim 9, wherein the processor is configured to perform further operations comprising:
rewarding the user in response to the sale of the access to the user at the one of the plurality of sites to an aggregator.

16. The tangible computer readable medium of claim 9, wherein the plurality of sites comprise a plurality of websites and wherein the access to track the user allows the aggregator to track the user when the user visits one of the plurality of websites.

17. An apparatus for providing services to an aggregator, the apparatus comprising:
a memory storing computer program instructions; and
a controller communicatively coupled to the memory, the controller configured to execute the computer program instructions, which, when executed on the controller, cause the controller to perform operations comprising:
preventing a user from being identified at each of a plurality of sites;
receiving an indication from the user to sell access to the user at one of the plurality of sites;
providing a personal information marketplace to run an auction to sell the access to the user at the one of the plurality of sites; and
in response to a sale of the access to the user at the one of the plurality of sites to an aggregator, providing to the aggregator, access to track the user at the one of the plurality of sites while maintaining anonymity of the user.

18. The apparatus of claim 17, wherein the preventing the user from being identified further comprises substituting a real internet protocol address of the user with a random proxy internet protocol address, and wherein the random proxy internet protocol address dynamically changes when the user visits a site.

19. The apparatus of claim 18, wherein the trusted frame is in communication with a remote server.

20. The apparatus of claim 19, wherein the fixed proxy internet protocol address changes to a new fixed proxy internet protocol address after the predetermined period of time.
